(19) United States
(12) Patent Application Publication
(10) Pub. No.: US 2026/0323411 A1
(43) Pub. Date: Oct. 15, 2026

(54) FAST SECONDARY CELL MEASUREMENT REPORTING

(71) Applicant: Apple Inc., Cupertino, CA (US)

(72) Inventors: Fangli Xu, Beijing (CN); Jie Cui, Cupertino, CA (US); Yang Tang, Cupertino, CA (US); Haijing Hu, Cupertino, CA (US)

(73) Assignee: Apple Inc., Cupertino, CA (US)

(21) Appl. No.: 19/485,492

(22) PCT Filed: May 19, 2023
(86) PCT No.: PCT/CN2023/095300

§ 371 Date: Nov. 18, 2025

(51) Int. Cl. H04W 36/00; H04W 24/10; H04W 76/27

(52) U.S. Cl. CPC H04W 36/0058; H04W 24/10; H04W 76/27

(57) ABSTRACT

The present application relates to devices and components including apparatus, systems, and methods to facilitate fast secondary cell (SCell) radio resource management (RRM) measurement reporting in wireless communication systems.

### TECHNICAL FIELD

The present application relates to the field of wireless technologies and, in particular, to facilitating fast secondary cell (SCell) radio resource management (RRM) measurement reporting in wireless communication systems.

### BACKGROUND

Third Generation Partnership Project (3GPP) networks allow user equipment (UE) to connect with multiple cells, including secondary cells (SCells). The network provides information to the UE to activate the cells. The UE can perform an activation procedure for the cells, including performing measurements related to the cells and reporting the measurements to the network. The network can utilize the results from the measurement report to provide operation for the UE.

### BRIEF DESCRIPTION OF THE DRAWINGS

FIG. 1 illustrates an example signaling framework in accordance with some embodiments.

FIG. 2 illustrates an example signaling framework in accordance with some embodiments.

FIG. 3 illustrates a flowchart of an example procedure for fast secondary cell (SCell) radio resource management (RRM) measurement reporting in accordance with some embodiments.

FIG. 4 illustrates an example medium access control (MAC) control element (CE) in accordance with some embodiments.

FIG. 5 illustrates an example MAC CE in accordance with some embodiments.

FIG. 6 illustrates an example procedure of operating a user equipment (UE) in accordance with some embodiments.

FIG. 7 illustrates an example procedure of operating a base station in accordance with some embodiments.

FIG. 8 illustrates an example procedure of operating a UE in accordance with some embodiments.

FIG. 9 illustrates example beamforming circuitry in accordance with some embodiments.

FIG. 10 illustrates an example UE in accordance with some embodiments.

FIG. 11 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

### Even Further Radio Resource management (RRM) ENHANCEMENT for New Radio (NR) and Multi-Radio Access Technology Dual Connectivity (MR-DC) (RP-221696)

Justification for the work item for even further RM enhancement for NR and MR-DC may include the following. This work item introduces several enhancements for NR and MR-DC RRM requirements. (1) Frequency range 2 (FR2) secondary cell (SCell) activation delay reduction. It is observed that some of the FR2 RRM requirements allow excessively long delay for UE in certain RRM operations. It is also observed that there are feasible ways to enhance specific requirements to guarantee fair performance in the field for FR2 networks, e.g., FR2 SCell activation delay requirement. For example, legacy approaches can provide for relatively excessive long delay time for FR2 SCell activation. Approaches described herein may reduce the delay time for FR2 SCell activation, thereby providing for improved operation of networks.

(2) Frequency range 1 (FR1)-FR1 NR-DC scenarios. FR1+FR1 NR-DC band combinations were introduced in release 16 (Rel-16) and the relevant deployment scenarios are expected to be used globally. However, the RRM requirements for FR1+FR1 NR-DC are missing, which may negatively affect the overall performance in NR-DC scenarios and shall be specified.

Objective of system information (SI) or Core part work item (WI) or Testing part WI may be as follows. The following objectives are considered in this WI. FR2 SCell activation delay reduction may be an objective. For example, an objective may be to identify cases where FR2 SCell activation delay can be reduced (e.g., unknown target cell cases), and specify reduced delay requirements for such cases, including but not limited to [radio access network group 4(RAN4 )]. Further, an objective may be to study and, if feasible, enhance cell detection for unknown SCell and time/frequency tracking. Another objective may be to study and, if feasible, enhance layer 1 (LI)-reference signal received power (RSRP) measurement delay reduction on target SCell. Subject to RAN4's agreement, the technical approaches can be extended to other general RRM requirements if applicable. Another objective may be to specify, if needed, reference signal enhancement and/or signaling enhancement for the UE to meet the enhanced delay requirements [RAN4, radio access network group 2 (RAN2)]. No radio access network group 1 (RAN1) work (i.e., introducing new RS) is expected. The technical approaches can be extended to FR1, when applicable

Another objective may be to define RRM requirements for FR1−FR1 NR-DC scenarios [RAN4]. RRM requirements include the number of serving carriers, primary serving cell (PSCell) addition/release delay requirement, PSCell change and conditional PSCell change delay, scheduling availability, and carrier-specific scaling factor (CSSF). Other release 15 (Rel-15) requirements are not precluded and are subject to WI stage discussion. For release 16 (R 16) and release 17 (R 17 ) features, RRM requirements for FR 1 -FR1 NR-DC including handover (HO) with PSCell, secondary cell group (SCG) activation/deactivation and conditional PSCell addition and change (CPAC) may be considered. No other R16 or R17 features are considered.

### RAN4 Liaison Statement (LS) (R4-2306321)

RAN4 is discussing how to reduce the FR2 unknown SCell activation delay for release 18 (R18) even further enhanced RRM (eFeRRM) WI, and in RAN4 #106-bis-e meeting there were some agreements achieved for the enhancements. Such FR2 unknown SCell activation enhancements may need RAN2 expertise for signaling design, and therefore RAN4 would like to ask RAN2's help on the following aspects. In Enhancement 1, network triggering report (of layer 3 (L3) measurement result) during FR2 unknown SCell activation may be considered. When SCell activation MAC CE is received and UE has valid L3 measurement results available but not reported, RAN4 agreed that SCell activation delay can be shortened if the available L3 measurement results are reported to network (NW). RAN4 agreed that following aspects of the above said report of L3 measurement results need RAN2 expertise and requests RAN2 to design approaches for the following aspects. For a first aspect, how to configure the report of L3 measurement result. For a second aspect, how to trigger the report of L3 measurement result. For a third aspect, contents of the report of L3 measurement result and how to send the report.

For the first aspect, how to configure the report of L3 measurement result for unknown FR2 SCell activation enhancement may be addressed. A technical enhancement goal for the first aspect may include the network configuring UE to report L3 measurement result when triggering conditions in the second aspect are met. It was RAN4 understanding that a one-time report may be configured. The type of report configuration may be a RAN2 decision. An action request to RAN2 may be RAN4 requests RAN2 to design corresponding signaling for the technical enhancement goal above.

For the second aspect, how to trigger the report of L3 measurement result for unknown FR2 SCell activation enhancement may be addressed. A technical enhancement goal for the second aspect may include RAN4 having following agreements in RAN4 #106-bis-e meeting. The agreements (from GTW, Monday Apr. 17, 2023) may include the L3 measurement report for unknown FR2 Scell activation after Scell activation MAC CE is triggered by Scell activation MAC CE. For further study (FFS) may be whether to have additional events for report triggering. An action request to RAN2 may be RAN4 requests RAN2 to decide how the measurement report gets triggered by SCell activation MAC CE. RAN4 requests RAN2 to design the corresponding signaling and decide whether a new event is needed to achieve above technical enhancement goal.

For the third aspect, contents of the report of L3 measurement result for unknown FR2 SCell activation enhancement and how to send the report may be addressed. A technical enhancement goal for the third aspect may include RAN4 having following agreements in RAN 4#106 -bis-e meeting. The agreements (from GTW, Monday Apr. 17, 2023) may include that user equipment (UE) needs to report the L3 measurement result after SCell activation MAC CE. An agreement (from 2nd round issue 1-1-5 of R4-2306315) may include UE reporting L3 measurement result with synchronization signal block (SSB) index for unknown FR2 SCell activation enhancement. An action request to RAN2 may be RAN4 requests RAN2 to design corresponding signaling for “report of L3 measurement result” after SCell activation MAC CE for unknown FR2 SCell activation enhancement. It's up to RAN2's decision on which layer's signaling shall be used to send the report to NW.

An issue statement may be, according to the questions indicated in RAN4 LS, RAN2 needs to design the approaches to address the three aspects above. For example, the approaches described herein may define how to configure the report of L3 measurement results for unknown FR2 SCell activation. Further, the approaches described herein may define how to trigger the report of L3 measurement results for unknown FR2 SCell activation enhancement. Additionally, the approaches described herein may define the contents of the report of L3 measurement results for unknown FR2 SCell activation enhancement and how to send the report.

### Framework

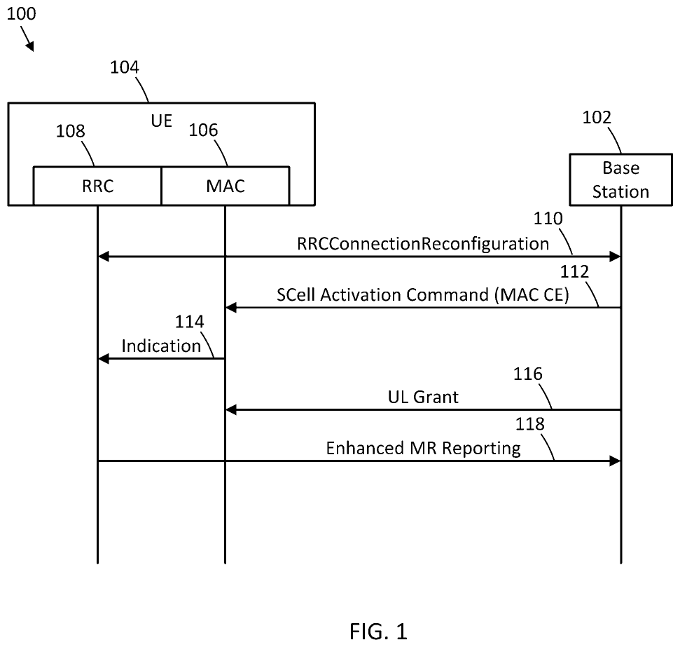

FIG. 1 illustrates an example signaling framework 100 in accordance with some embodiments. In particular, the signaling framework 100 illustrates signals that may be exchanged between a base station of a network and a UE. For example, the signaling framework 100 illustrates operations that may be performed for reducing FR2 SCell activation delay in accordance with approaches described herein.

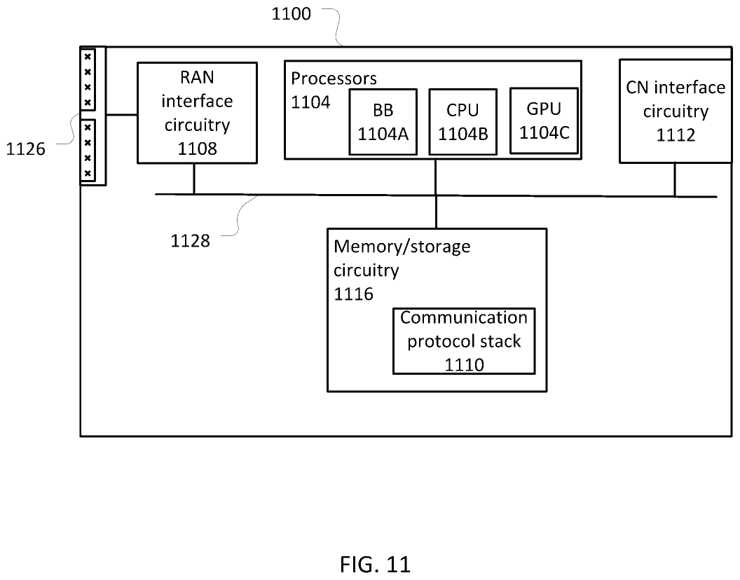

The signaling framework 100 may include a base station 102. The base station 102 may include one or more of the features of the next generation NodeB (gNB) 1100 (FIG. 11). The base station 102 may be a portion of a network that can provide services to UEs. The network may utilize the base station 102 to communicate with UEs.

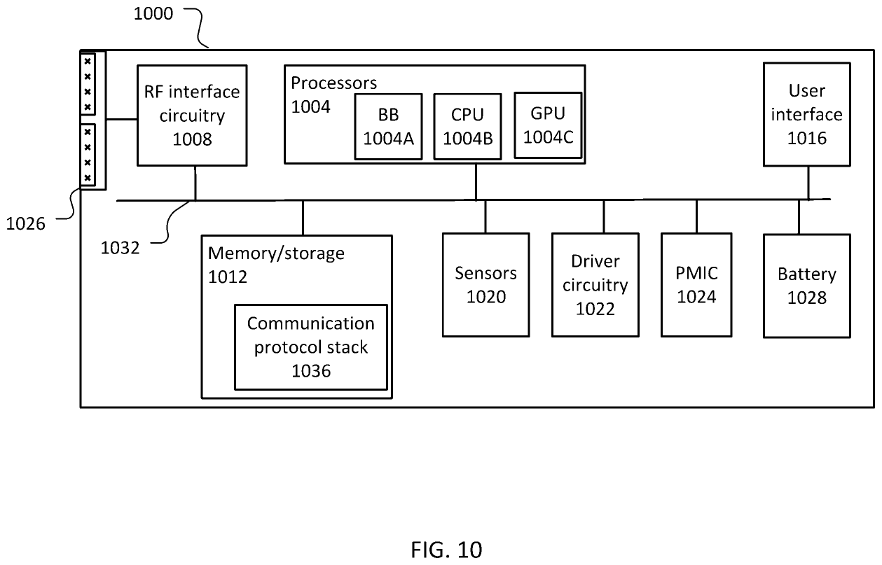

The signaling framework 100 may include a UE 104. The UE 104 may include one or more of the features of the UE 1000 (FIG. 10). The UE 104 may operate a medium access control (MAC) layer 106 and a radio resource control (RRC) layer 108. The MAC layer 106 may perform operations related to the MAC of the UE 104 and the RRC layer 108 may perform operations related to the RRC of the UE 104.

The UE 104 may establish a connection with the base station 102. Based on the connection between the base station 102 and the UE 104, the network (via the base station 102) may provide services to the UE 104. One of these services that the services that can be provided to the UE 104 via the base station may include FR2 SCell activation. The signals and operations described herein as being performed between the base station 102 and the UE 104 may be part of the FR2 SCell activation. In particular, the signals and operations may relate to a procedure for fast SCell RRM measurement reporting.

The signaling framework 100 illustrated in FIG. 1, and the description corresponding to the signal framework 100, may describe a general procedure. The general procedure is an example general overview of a procedure related to the FR2 SCell activation, which further details of the procedure are described throughout this disclosure.

A first operation illustrated by the signaling framework 100 may include configuration. For example, a first operation of the procedure for fast SCell RRM measurement reporting may include configuring the UE 104 for the fast SCell RRM measurement reporting. When network provides the RRC configuration for SCell #X addition, network enable the fast SCell RRM measurement reporting. For example, the base station 102 may perform an RRC connection reconfiguration 110 with the UE 104. The RRC connection reconfiguration 110 may include a configuration for the fast SCell RRM measurement reporting. In a first option, the configuration for the fast SCell RRM measurement reporting may be in an SCell #X addition part of the RRC connection reconfiguration 110. In a second option, the configuration for the fast SCell RRM measurement reporting may be in a measurement configuration part of the RRC connection reconfiguration 110.

The base station 102 may transmit an SCell activation MAC control element (CE) 112. The SCell activation MAC CE 112 may include an indication of SCells to be activated. Further, the SCell activation MAC CE 112 may indicate to the UE 104 which SCells will be enabled for fast SCell RRM measurement reporting in some embodiments. The SCell activation MAC CE 112 may be received by the MAC layer 106 of the UE 104. Accordingly, the MAC layer 106 of the UE 104 may process the SCell activation MAC CE 112 and, in some embodiments, determine the SCells that will be enabled for fast SCell RRM measurement reporting. In some embodiments, the UE 104 may be configured to perform measurements of the determined SCells and/or generate a fast SCell RRM measurement report within a time period of receiving the SCell activation MAC CE 112.

A second operation illustrated by the signaling framework 100 may include trigger. The MAC layer 106 may inform the RRC layer 108 of the event when receiving the SCell activation MAC CE 112. For example, the MAC layer 106 may indicate an event that is to trigger a fast SCell RRM measurement report to the RRC layer 108. In a first option (explicit approach), 1-flag per SCell may be included the SCell activation MAC CE 112. For example, the SCell activation MAC CE 112 may include one or more flags, where each of the flags corresponds to a corresponding SCell. The values of the flags may indicate which SCells are to be enabled for fast SCell RRM measurement reporting. The MAC layer 106 may determine the SCells to be enabled for fast SCell RRM measurement reporting based on the values of the flags. In a second option (implicit way), only based on RRC configuration. For example, the SCell activation MAC CE 112 may be the same as the legacy SCell activation MAC CE for SCell activation. The MAC layer 106 may determine that the preconfiguration from the RRC connection reconfiguration 110 provides the SCells to be enabled for the fast SCell RRM measurement reporting.

The MAC layer 106 may inform the RRC layer 108 of the information determined from the SCell activation MAC CE 112. For example, the MAC layer 106 may provide an indication 114 to the RRC layer 108. The indication 114 may indicate the information determined from the SCell activation MAC CE 112. For example, the indication 114 may indicate the event that is to trigger the fast SCell RRM measurement report. Further, the indication 114 may indicate the SCells that are to be enabled for fast SCell RRM measurement reporting determined from the flags of the SCell activation MAC CE 112 in the first option. In the second option, the indication 114 may indicate that the RRC layer 108 is to utilize the preconfiguration from the RRC connection reconfiguration 110 to determine which SCells are to be enabled for fast SCell RRM measurement reporting.

The RRC layer 108 of the UE 104 may check whether the condition for fast SCell measurement report (MR) is met. For example, the RRC layer 108 may determine whether the condition for the fast SCell RRM measurement report is met. The RRC layer 108 may determine whether the condition is met based on the trigger for the fast SCell RRM measurement report occurring.

A first option for the condition may be an unknown SCell. For example, the RRC layer 108 may determine whether the SCell for which an SCell RRM measurement report is to be generated is an unknown SCell as the condition. The SCell may be unknown if a measurement report has not been previously provided for the SCell or a measurement report for the SCell has not been provided within a threshold amount of time from the current trigger. The first option for the condition may be met based on SCell being unknown and may not be met based on a measurement report for the SCell being previously provided to the base station 102 or being previously provided to the base station 102 within a threshold amount of time.

A second option for the condition may be that the RRC has the available measurement result. For example, the condition may be whether the RRC layer 108 has measurement result data for the SCell that has not been previously provided to the base station 102. Option 1 may be an available measurement result is the available L3 measurement result after L3 filter. For example, the RRC layer 108 may have an L3 measurement result after L3 filter for the SCell available for transmission in some instances. The condition of the RRC layer 108 having measurement results available may be met by the RRC layer 108 having the L3 measurement result after L3 filter for the SCell available in these instances. Option 2 may be an available measurement result is the available layer 1 (L1) measurement result. For example, the RRC layer 108 may have an L1 measurement result available for transmission in some instances. However, the RRC layer 108 may not have an L3 measurement result available for transmission in some of these instances. In this instance, the condition of the RRC layer 108 having measurement results available may be met by the RRC layer 108 having the L1 measurement result available for transmission. Option 3 may be an available measurement result may include the case that UE has no available L1/L3 result. For example, the RRC layer 108 may have neither L1 measurement results nor L3 measurement results available for transmission. In this instance, the UE can have a codepoint to include in a measurement report that indicates that no measurement results are available. In this instance, the condition may be met by the determination that the UE does not have a measurement report available, but can provide an indication that no measurement results are available.

A third operation illustrated by the signaling framework 100 may include reporting. UE may assemble the fast MR report when condition is met and initiate the transmission. For example, the UE 104 may assemble a fast SCell RRM measurement report for transmission to the base station 102 based on the condition being met.

In a first option for the reporting, RRC may assemble the measurement report as the MR triggered as today. For example, the RRC layer 108 may assemble a fast SCell RRM measurement report based on the condition being met. The RRC layer 108 may have measurement results for the SCell and assemble the measurement results in the fast SCell RRM measurement report in accordance with the configuration for the fast SCell RRM measurement reporting provided in the RRC connection reconfiguration 110. In MR, it includes the cell quality and good/best beam index list (optionally together with beam quality). For example, the fast SCell RRM measurement report in the first option for reporting may include a cell quality for the SCell and/or a good/best beam index list for the SCell. The good/best beam index list may include beams that exceed a threshold quality value. In some embodiments, the fast SCell RRM measurement report may further include a beam quality related to the SCell.

In a second option for the reporting, RRC may assemble the measurement report with the special content. For example, the RRC layer 108 may assemble a fast SCell RRM measurement report based on the condition being met. The RRC layer 108 may have measurement results for the SCell and assemble the measurement results in the fast SCell RRM measurement report in accordance with the configuration for the fast SCell RRM measurement reporting provided in the RRC connection reconfiguration 110. In MR, it may only include the SCell's measurement result. For example, the fast SCell measurement report may be limited to the measurement result for the SCell. In a first option of the information included in the measurement report (which may be referred to as Option 2.1), the measurement report may include cell quality+good/best beam index list (optionally include the beam quality). For example, the fast SCell RRM measurement report may include a cell quality for the SCell and/or a good/best beam index list for the SCell. In some embodiments, the fast SCell RRM measurement may further include a beam quality related to the SCell. In a second option of the information included in the measurement report (which may be referred to Option 2.2), the measurement report may include good/best beam index list (optionally include the beam quality). For example, the fast SCell RRM measurement report may include a good/best beam index list. The good/best beam index list may include beams that exceed a threshold quality value. In some embodiments, the fast SCell RRM measurement may further include a beam quality related to the SCell.

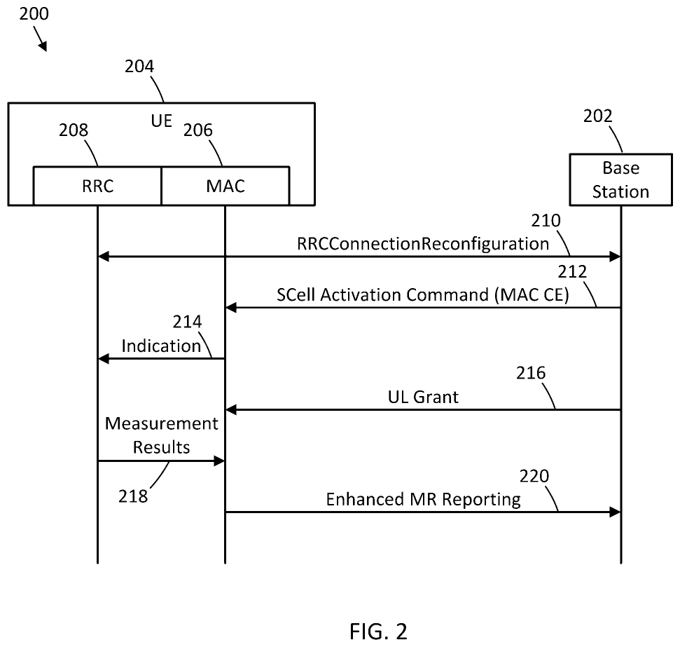

In a third option for the reporting, MAC may assemble the report (new SCell). For example, the MAC layer 106 may assemble a fast SCell RRM measurement report based on the condition being met. As the RRC layer 108 may produce the measurement results for the SCell. For the MAC layer 106 to assemble the fast SCell RRM measurement report, the RRC layer 108 may provide the measurement results to the MAC layer 106 to assemble the fast SCell RRM measurement report. The MAC layer 106 assembling the measurement report is described further in relation to FIG. 2. New MAC CE for fast SCell MR reporting, content is same as Option 2 in RRC message. For example, the MAC layer 106 may generate a MAC CE that includes the fast SCell RRM measurement report for transmission to the base station 102. In some embodiments, the fast SCell RRM measurement report in the MAC CE may include a cell quality for the SCell and/or a good/best beam index list for the SCell. Further, the fast SCell RRM measurement report may include a beam quality related to the SCell in some of these embodiments. In some other embodiments, the fast SCell RRM measurement report in the MAC CE may include a good/best beam index list for the SCell. The good/best beam index list may include beams that exceed a threshold quality value. Further, the fast SCell RRM measurement report may further include a beam quality related to the SCell.

UE can deliver the data to network if there is any uplink (UL) grant for new data transmission. For example, the UE 104 may transmit the assembled fast SCell RRM measurement report to the base station 102 on a data transmission granted by a UL grant from the base station 102. The base station 102 may transmit a UL grant 116 to the UE 104 that indicates a resource available for transmission of the fast SCell RRM measurement report. The UE 104 may determine the resource available for the fast SCell RRM measurement report based on the UL grant 116. In some embodiments, the UL grant 116 may be for a resource at a time after the time period for generating the fast SCell RRM measurement report after the reception of the SCell activation MAC CE 112 by the UE 104. For example, the network may schedule the UL grant 116 to be for a resource after a time that the UE 104 should generate a fast SCell RRM measurement report if measurements of the SCell are available. The UE 104 may transmit the fast SCell RRM measurement report to the base station 102 in an enhanced MR reporting 118. The network may utilize the measurement results from the fast SCell RRM measurement report to determine operations for the UE 104, including operations related to the SCell (or SCells) corresponding to the fast SCell RRM measurement report. In the instance that measurements for the SCell (or SCells) are not available, the UE 104 may not transmit a fast SCell RRM measurement report to the base station 102. If the base station 102 does not receive a fast SCell RRM measurement report on the resource corresponding to the UL grant 116, the network may assume that measurements of the SCell (or SCells) are not available from the UE 104 in some embodiments, such as when the resource is at a time after the time period for the UE 104 to generate a fast SCell RRM measurement report from the SCell activation MAC CE 112.

Optionally, in dual connectivity (DC) mode, the report can be restricted to be transmitted in the cell group (CG) it belongs to. For example, the UE 104 may limit the transmission of fast SCell RRM measurement report for an SCell to the CG that includes the SCell. For example, a primary cell (PCell) of a master cell group (MCG) and a PCell of a secondary cell group (SCG) may maintain the measurement results for each CG separately. The UE 104 may monitor for a UL grant (such as the UL grant 116) for a resource within a CG corresponding to the SCell measured. If a UL grant is for a resource within a different CG than the SCell, the UE 104 may not utilize the resource for transmitting the fast SCell RRM measurement report.

FIG. 2 illustrates an example signaling framework 200 in accordance with some embodiments. In particular, the signaling framework illustrates signals that may be exchanged between a base station of a network and a UE. The signaling framework 200 illustrates signals that may be transmitted in accordance with the third option of reporting described in relation to the signaling framework 100 of FIG. 1.

The signaling framework 200 may include one or more of the features of the signaling framework 100 (FIG. 1). In particular, the signaling framework 200 may include a base station 202 that includes one or more of the features of the base station 102 (FIG. 1), and a UE 204 that includes one or more of the features of the UE 104 (FIG. 1). The base station 202 and the UE 204 may exchange an RRC connection reconfiguration 210 that includes one or more of the features of the RRC connection reconfiguration 110 (FIG. 1), an SCell activation MAC CE 212 that includes one or more of the features of the SCell activation MAC CE 112 (FIG. 1), an indication 214 that includes one or more of the features of the indication 114 (FIG. 1), and a UL grant 216 that includes one or more of the features of the UL grant 116 (FIG. 1).

For the signaling framework 200, a MAC layer 206 of the UE 204 may assemble a fast SCell RRM measurement report related to an SCell. For the MAC layer 206 to assemble the fast SCell RRM measurement report, an RRC layer 208 of the UE 204 may provide measurement results for the SCell to the MAC layer 206. In particular, the RRC layer 208 may provide the measurement results 218 to the MAC layer 206. The MAC layer 206 may assemble the fast SCell RRM measurement report with the measurement results 218 received from the RRC layer 208. In some embodiments, the fast SCell RRM measurement report may include a cell quality for the SCell and/or a good/best beam index list for the SCell. The good/best beam index list may include beams that exceed a threshold quality value. Further, the fast SCell RRM measurement report may include a beam quality related to the SCell in some embodiments. In some other embodiments, the fast SCell RRM measurement report may include a good/best beam index list for the SCell. The good/best beam index list may include beams that exceed a threshold quality value. Further, the fast SCell RRM measurement report may further include a beam quality related to the SCell.

The fast SCell RRM measurement report may be included in a MAC CE to be transmitted to the base station 202. The MAC layer 206 may transmit an enhanced MR reporting 220 including the fast SCell RRM measurement report to the base station 202. The MAC layer 206 may transmit the enhanced MR reporting 220 on the resource indicated by the UL grant 216.

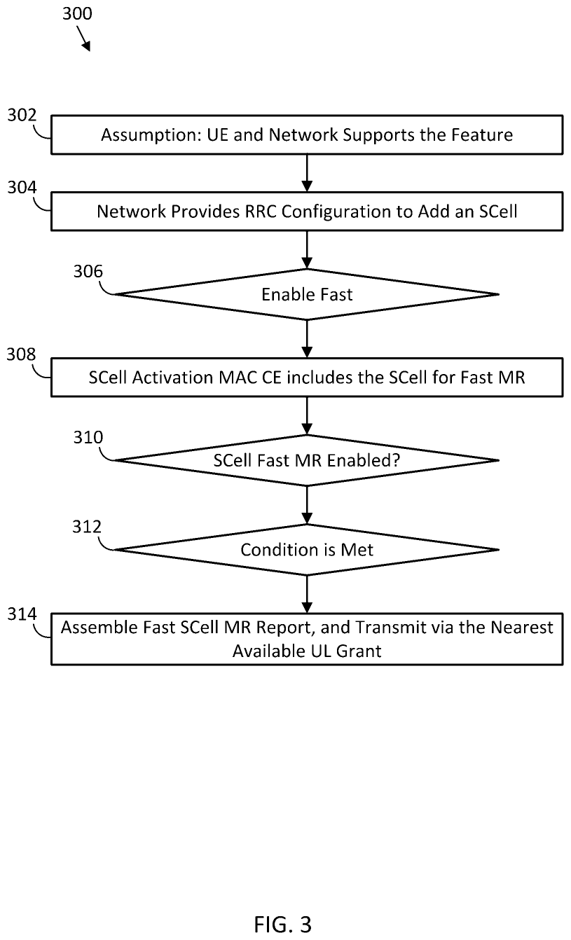

FIG. 3 illustrates a flowchart of an example procedure 300 for fast SCell RRM measurement reporting in accordance with some embodiments. For example, the flowchart of the procedure 300 illustrates operations and/or decisions may be performed as part of a fast SCell RRM measurement reporting. Portions of the procedure 300 may be performed by a UE (such as the UE 104 (FIG. 1), the UE 204 (FIG. 2), and/or the UE 1000 (FIG. 10)) and/or a base station (such as the base station 102 (FIG. 1), the base station 202 (FIG. 2), and/or the gNB 1100 (FIG. 11)).

The procedure 300 may include the UE and a network (including the base station) supporting the feature in 302. In particular, the UE and the base station may support the fast SCell RRM measurement reporting. In some embodiments, the UE and the base station both may be configured to support the fast SCell RRM measurement reporting. In some embodiments, the UE and the base station may exchange communications to indicate that both the UE and the base station support the fast SCell RRM measurement reporting.

In 304, the network may provide an RRC configuration to add an SCell. For example, the network, via the base station, may transmit an RRC connection reconfiguration (such as the RRC connection reconfiguration 110 (FIG. 1) and/or the RRC connection reconfiguration 210 (FIG. 2)) to the UE. The RRC connection reconfiguration may indicate an SCell to be added to the UE. The RRC connection reconfiguration may include a configuration for the fast SCell RRM measurement reporting, as described in relation to the RRC connection reconfiguration 110.

In 306, the fast SCell measurement reporting may be determined to be enabled. For example, the UE may determine that fast SCell measurement reporting is to be enabled for the SCell. The UE may determine that the fast SCell measurement reporting is to be enabled for the SCell based on the RRC connection reconfiguration received from the base station.

In 308, an SCell activation MAC CE (such as the SCell activation MAC CE 112 (FIG. 1) and/or the SCell activation MAC CE 212 (FIG. 2)) may include the SCell for fast MR. For example, the base station may transmit an SCell activation MAC CE to the UE that includes an indication of the SCell for which a fast SCell RRM measurement report is to be generated.

In 310, it may be determined whether SCell fast MR is enabled. For example, the UE may determine whether an SCell has fast SCell RRM measurement report is enabled. In some embodiments, determining whether an SCell has fast SCell RRM measurement report enabled may include a MAC layer (such as the MAC layer 106 (FIG. 1) and/or the MAC layer 206 (FIG. 2)) providing an indication (such as the indication 114 (FIG. 1) and/or the indication 214 (FIG. 2)) to an RRC layer (such as the RRC layer 108 (FIG. 1) and/or the RRC layer 208 (FIG. 2)) that indicates the SCell for which fast SCell RRM measurement reporting is to be performed.

In 312, it may be determined whether a condition for the fast SCell measurement report is met. For example, the UE may determine whether a condition for providing a fast SCell RRM measurement report is met. The condition may include any of the conditions described in relation to the signaling framework 100 (FIG. 1), such as the conditions related to the trigger operation.

In 314, a fast SCell MR may be assembled, and may be transmitted via the nearest available UL grant. For example, a fast SCell MR (such as a fast SCell RRM measurement report) may be assembled based on the condition being determined to be met in 312. The fast SCell MR may be assembled by the RRC layer of the UE or the MAC layer of the UE, as described in relation to the signaling framework 100 and/or the signaling framework 200. The base station may provide a UL grant (such as the UL grant 116 (FIG. 1) and/or the UL grant 216 (FIG. 2)) to the UE that indicates a resource that can be utilized for transmitting the fast SCell MR to the base station. The UE may determine the resource for the fast SCell MR based on the UL grant. The RRC layer or the MAC layer may transmit the fast SCell MR to the base station in an enhanced MR reporting (such as the enhanced MR reporting 118 (FIG. 1) and/or the enhanced MR reporting 220 (FIG. 2)), as described further in relation to the signaling framework 100 and/or the signaling framework 200.

### Fast SCell MR Configuration

A base station (such as the base station 102 (FIG. 1), the base station 202 (FIG. 2), and/or the gNB 1100 (FIG. 11)) may provide a configuration for fast SCell RRM measurement reporting to a UE. For example, the base station may transmit an RRC connection reconfiguration (such as the RRC connection reconfiguration 110 (FIG. 1) and/or the RRC connection reconfiguration 210 (FIG. 2)) to the UE that can configure the UE for fast SCell RRM measurement reporting. In a first option, the configuration for the fast SCell RRM measurement reporting may be included in an SCell #X addition part of the RRC connection reconfiguration. In RRCReconfiguration for SCell addition, it includes the following two parameters to enable the fast SCell MR: Fast SCell MR configuration in the SCell serving configuration; and serving measurement object (ServingMO). For example, the RRC connection reconfiguration to enable the fast SCell RRM measurement reporting may include a fast SCell MR configuration in the SCell serving configuration and/or a servingMO. The servingMO may indicate an object to be utilized for performing a measurement of the SCell.

In a second option, the configuration for fast SCell RRM measurement reporting may be included in a measurement configuration part (new event +serving cell measurement object (MO) on new SCell #X). In RRCReconfiguration for new SCell addition, it includes the new measurement configuration for the fast MR report (i.e., new measurement identifier (ID), and the associated MO and event configuration). For example, the RRC connection reconfiguration to enable the fast SCell RRM measurement reporting may include a measurement configuration for the fast SCell RRM measurement report. The measurement configuration may include a new measurement ID, and the associated MO and event configuration for the fast SCell RRM measurement reporting. The new MO may be same as the serving MO for the new added SCell. The new event configuration may trigger the fast SCell MR report upon SCell activation, and in the event, it may include the beam reporting part configuration. For example, the event configuration included in the measurement configuration may include a trigger for the fast SCell RRM measurement report of an SCell activation and may include a beam reporting part configuration.

### Fast SCell MR trigger

The SCell activation MAC CE trigger may have two options for performance. In a first option (the explicit way), the SCell activation MAC CE may include 1-flag per SCell. For example, the SCell activation MAC CE (such as the SCell activation MAC CE 112 (FIG. 1) and/or the SCell activation MAC CE 212 (FIG. 2)) may include one or more flags, where each flag corresponds to a corresponding SCell. The flags may indicate which of the corresponding SCells are to be triggered for fast SCell RRM measurement reporting. In a second option (the implicit way), whether fast SCell RRM measurement reporting is triggered may only be based on RRC configuration. For example, a configuration provided in an RRC connection reconfiguration (such as the RRC connection reconfiguration 110 (FIG. 1) and/or the RRC connection reconfiguration 210 (FIG. 2)) may define which SCell are to have fast SCell RRM configuration reporting triggered.

In the first option, the triggering of the fast SCell RRM measurement reporting may include explicit indication per SCell in SCell activation MAC CE. For example, an SCell activation MAC CE (such as the SCell activation MAC CE 112 and/or the SCell activation MAC CE 212) may include an explicit indication per SCell of which SCells are to be triggered for the fast SCell RRM measurement reporting. New MAC CE is introduced to include the 1-bit indication (e.g., F field).

FIG. 4 illustrates an example MAC CE 400 in accordance with some embodiments. For example, the MAC CE 400 illustrates an example of a MAC CE utilized for the first option including the explicit indication per SCell. The MAC CE 400 may be included in an SCell activation MAC CE (such as the SCell activation MAC CE 112 (FIG. 1) and/or the SCell activation MAC CE 212 (FIG. 2))

The MAC CE 400 may include one or more indications of SCells 402. In some embodiments, the indications of the SCells 402 may include cell IDs corresponding to the SCells. The MAC CE 400 may further include one or more flags 404. Each indication of the SCells of the indications of SCells 402 has a corresponding flag of the flags 404. The flag may have a value that indicates whether the corresponding SCell is to be triggered for the fast SCell RRM measurement reporting. For example, the indication of SCells 402 may include an indication of a first SCell 406. The flags 404 may include a first flag 408 that corresponds to the indication of the first SCell 406. A value of the first flag 408 may indicate whether the first SCell is to be triggered for the fast SCell RRM measurement reporting. For example, the first flag 408 having a value of one may indicate that the first SCell is to be triggered for the fast SCell RRM measurement reporting and the first flag 408 having a value of zero may indicate that the first SCell is not to be triggered for the fast SCell RRM measurement reporting.

The explicit indication may lead to interaction between MAC and RRC. For example, an MAC layer of a UE (such as the MAC layer 106 (FIG. 1) and/or the MAC layer 206 (FIG. 2)) may interact with an RRC layer of the UE (such as the RRC layer 108 (FIG. 1) and/or the RRC layer 208 (FIG. 2) to implement the operations from the explicit indication. In a first stage, if UE MAC receives the new SCell activation MAC CE, for the SCell with the fast MR indication, MAC informs RRC the fast MR trigger with the SCell index. For example, the MAC layer of the UE may receive the SCell activation MAC CE. The MAC layer may determine the one or more SCells indicated to be triggered for the fast SCell RRM measurement reporting within the SCell activation MAC CE. The MAC layer may provide the RRC layer with an indication of the SCells to be triggered for the fast SCell RRM measurement reporting. The indication of the Scells may include SCell index for the SCells to be triggered for the fast SCell RRM measurement reporting. In a second stage, RRC starts the fast Scell MR condition evaluation for this indicated Scell. For example, the RRC layer may determine whether the SCell indicated by the MAC layer meet the condition defined for fast SCell RRM measurement reporting.

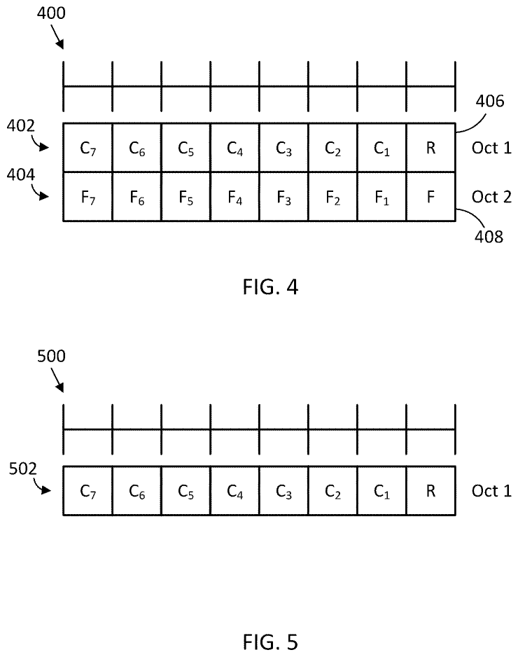

In the second option, the triggering of the fast SCell RRM measurement reporting may include implicit indication. In the second option, legacy SCell activation MAC CE may be reused. FIG. 5 illustrates an example MAC CE 500 in accordance with some embodiments. The MAC CE 500 may be utilized for the second option. The MAC CE 500 may include indications of SCells 502 to be triggered for fast SCell RRM measurement reporting.

The implicit indication may lead to interaction between MAC and RRC. In a first option for the MAC and RRC interaction for the implicit interaction, MAC informs RRC of all the activated SCells when receiving SCell activation MAC CE. For example, the MAC layer may determine SCells to be activated. The MAC layer may indicate to the RRC layer the SCells to be activated. In a second option for the MAC and RRC interaction for the implicit interaction, RRC informs MAC of the SCells configured with fast MR, and MAC only informs RRC of the activated SCells with fast MR when the SCell is activated for each time. For example, the RRC layer may provide an indication of the SCells configured for fast SCell RRM measurement reporting to the MAC layer. The MAC layer may determine which of the SCells configured for the fast SCell RRM measurement reporting are to be activated. The MAC layer may provide an indication of the SCells to be activated, where the indication includes only SCells configured for the fast SCell RRM measurement reporting.

### Multiple SCell Activation in one SCell Activation MAC CE

If one SCell activation MAC CE is to activate more than one SCell with fast MR configuration at the same time, UE operation may, in a first option, only trigger one SCell fast MR or, in a second option, trigger multiple SCell fast MRs. For example, an SCell activation MAC CE (such as the SCell activation MAC CE 112 (FIG. 1) and/or the SCell activation MAC CE 212 (FIG. 2)) may provide for more than one SCell with fast SCell RRM measurement reporting to be activated. In a first option, the SCell activation MAC CE may indicate that fast SCell RRM measurement reporting is to be triggered for one SCell, such as by having only a single flag (such as the flags 404 (FIG. 4)) indicating that a corresponding SCell is to be triggered for fast SCell RRM measurement reporting. In a second option, the SCell activation MAC CE may indicate that fast SCell RRM measurement reporting is to be triggered for multiple SCells, such as by having multiple flags indicating that corresponding SCells are to be triggered.

For the first option, only one SCell fast MR is triggered. In a first approach for the first option (which may be referred to as Option 1.1), a network may be restricted to only activate one SCell to trigger the fast MR. For example, a network may be limited to activating one SCell for fast SCell RRM measurement reporting at a time for a UE.

For the implicit trigger approach (i.e., using legacy SCell activation MAC CE), network only provides the SCell activation MAC CE including only one SCell with fast MR configuration. For example, an SCell activation MAC CE (such as the SCell activation MAC CE 112 (FIG. 1) and/or the SCell activation MAC CE 212 (FIG. 2)) may include an indication of one SCell having a configuration for fast SCell RRM measurement reporting to be activated.

For the explicit trigger approach (i.e., 1-bit fast MR indication in SCell activation MAC CE), network only indicates up to 1 SCell to trigger the fast MR per SCell activation MAC CE. For example, an SCell activation MAC CE may be limited to having a single flag corresponding to an SCell indicating that the SCell is to be triggered for fast SCell RRM measurement reporting.

In a second approach for the first option (which may be referred to as Option 1.2), network may activate/trigger multiple SCells with fast MR, and UE only select one SCell to provide the fast MR. For example, the network may indicate multiple SCells to be activated at one time for a UE. In a first option of the second approach (which may be referred to as Option 1.2.1), the UE only selects the 1st SCell (lowest SCell index) in the MAC CE to trigger the fast MR. For example, the UE may select one of the multiple SCells indicated by the network for activation. The UE may select the single SCell based on an SCell index corresponding to the SCell. For example, the UE may select the SCell with the lowest SCell index, the SCell with the highest SCell index, or the SCell with a predefined SCell index. The UE may utilize the selected SCell for performance of the fast SCell RRM measurement reporting.

In a second option of the second approach (which may be referred to as Option 1.2.2), it's up to UE to select one of the activated SCells with fast MR configuration to trigger the fast MR. For example, the network may indicate multiple SCells to be activated. The UE may determine one of SCells configured with fast SCell RRM measurement reporting from the multiple SCells to trigger a fast SCell RRM measurement reporting. The UE may determine the SCell based on a characteristic of the SCell (such as an SCell index, a measurement of the SCell, or another characteristic of the SCell), may determine the SCell based on a predefined selection operation, may randomly select the SCell, or may determine the SCell based on a run-time selection operation. In this second option, the SCell determined may not meet the condition for fast SCell RRM measurement reporting.

In a third option of the second approach (which may be referred to as Option 1.2.3), UE can select any activated SCell which meets the fast MR condition to trigger the MR. For example, the network may indicate multiple SCells to be activated. The UE may determine one of SCells configured with fast SCell RRM measurement reporting and that meets a condition for the fast SCell RRM measurement reporting from the multiple SCells to trigger a fast SCell RRM measurement reporting. The UE may determine the SCell based on a characteristic of the SCell (such as an SCell index, a measurement of the SCell, or another characteristic of the SCell), may determine the SCell based on a predefined selection operation, may randomly select the SCell, or may determine the SCell based on a run-time selection operation. In this third option, the SCell determined may meet the condition for fast SCell RRM measurement reporting.

For the second option of the multiple SCell activation, the UE can trigger the multiple SCell fast MRs at the same time. For example, the network may indicate multiple SCells to be activated to a UE. The UE may trigger the fast SCell RRM measurement reporting for the multiple SCells indicated by the network.

In a first approach for the second option (which may be referred to as Option 2.1), the UE can assemble multiple MRs, one per SCell event report. For example, the UE may have measurement results for multiple SCells indicated by the network to be activated. The UE may generate a fast SCell RRM measurement report for each of the multiple SCells that includes the measurement result corresponding to the SCell. For example, the UE may generate a first fast SCell RRM measurement report for a first SCell, a second fast SCell RRM measurement report for a second SCell, and so forth. The UE may transmit each of the fast SCell RRM measurement reports to the network, such as in one or more enhanced MR reportings (such as the enhanced MR reporting 118 (FIG. 1) and/or the enhanced MR reporting 220 (FIG. 2)).

In a second approach for the second option (which may be referred to as Option 2.2), the UE can only assemble one MR and including all the measurement results with beam info of all the activated SCells. For example, the UE may have measurement results for multiple SCells indicated by the network to be activated. The UE may generate a single fast SCell RRM measurement report that included the measurement results for the multiple SCells. For example, the UE may generate a fast SCell RRM measurement report that includes the measurement result for a first SCell, the measurement result for a second SCell, and so forth. The UE may transmit the fast SCell RRM measurement report to the network, such as in a single enhanced MR reporting (such as the enhanced MR reporting 118 and/or the enhanced MR reporting 220).

In a third approach for the third option (which may be referred to as Option 2.3), the UE can assemble the MR per CG, and for each MR it includes all the available measurement results with beam info of all the activated SCells belonging to same CG. For example, the UE may have measurement results for multiple SCells indicated by the network to be activated. The UE may further determine which CG includes each of the SCells. The UE may generate a single fast SCell RRM measurement report for each of the CGs, where the fast SCell RRM measurement report for a CG includes the measurement results for the SCells within the CG. For example, the UE may generate a first fast SCell RRM measurement report for a first CG that includes measurement results for a first SCell and a second SCell within the first CG, and a second fast SCell RRM measurement report for a second CG that includes measurement results for a third SCell and a fourth SCell within the second CG, and so forth. The UE may transmit the fast SCell RRM measurement reports to the network, such as in one or more enhanced MR reportings (such as the enhanced MR reporting 118 (FIG. 1) and/or the enhanced MR reporting 220 (FIG. 2)).

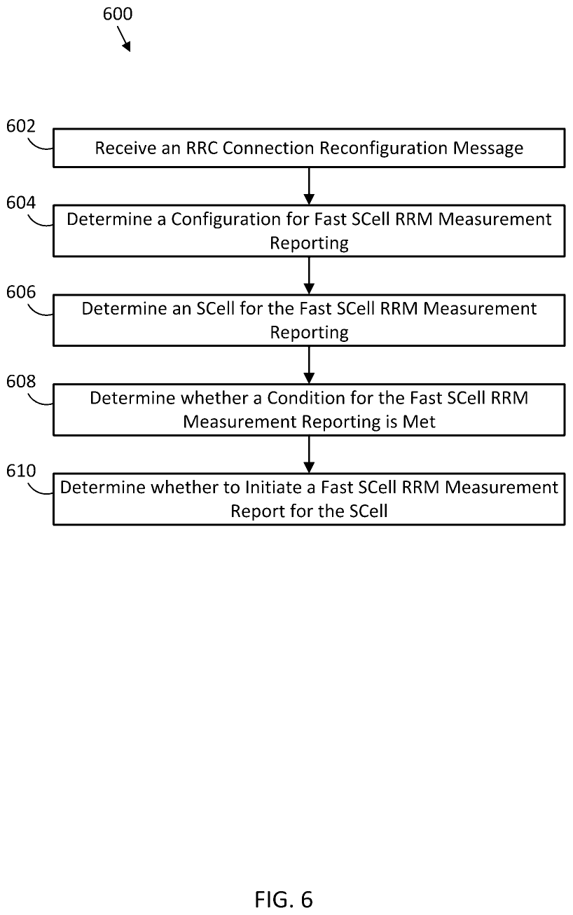

FIG. 6 illustrates an example procedure 600 of operating a UE in accordance with some embodiments. For example, the procedure 600 may facilitate fast SCell RRM measurement reporting. The procedure 600 may be performed by a UE, such as the UE 104 (FIG. 1), the UE 204 (FIG. 2), and/or the UE 1000 (FIG. 10).

The procedure 600 may include receiving an RRC connection reconfiguration message in 602. For example, the UE may receive an RRC connection reconfiguration message from a base station. The RRC connection reconfiguration message may include one or more of the features of the RRC connection reconfiguration 110 (FIG. 1) and/or the RRC connection reconfiguration 210 (FIG. 2).

The procedure 600 may include determining a configuration for fast SCell RRM measurement reporting in 604. For example, the UE may determine a configuration for fast SCell RRM measurement reporting based at least in part on the RRC connection reconfiguration message.

In some embodiments, the RRC connection reconfiguration message may comprise the configuration for the fast SCell RRM measurement reporting in an SCell addition part of the RRC connection reconfiguration or a measurement configuration part of the RRC connection reconfiguration message. In some embodiments, the configuration for the fast SCell RRM measurement reporting may comprise a fast SCell measurement report. configuration and a serving measurement object.

The procedure 600 may include determining an SCell for the fast SCell RRM measurement reporting in 606. For example, the UE may determine an SCell for the fast SCell RRM measurement reporting.

In some embodiments, the procedure 600 may further comprise receiving an SCell activation MAC CE that includes one-bit indications for each SCell in the SCell activation MAC CE. The SCell activation MAC CE may include one or more of the features of the SCell activation MAC CE 112 (FIG. 1) and/or the SCell activation MAC CE 212 (FIG. 2). In some of these embodiments, the SCell for the fast SCell RRM measurement reporting may be determined based at least in part on the one-bit indications within the SCell activation MAC CE.

Further, the SCell activation MAC CE may be received via a MAC layer of the UE in some embodiments. In these embodiments, the procedure 600 may further comprise indicating, via the MAC layer of the UE to an RRC layer of the UE, an SCell index corresponding to the SCell for the fast SCell RRM measurement reporting to indicate that the fast SCell RRM measurement reporting is to be performed for the SCell.

In some embodiments, the procedure 600 may further comprise indicating, via an RRC layer of the UE to a MAC layer of the UE, one or more SCells configured for the fast SCell RRM measurement reporting. The procedure 600 may further comprise indicating, via the MAC layer of the UE to the RRC layer of the UE, the SCell for the fast SCell RRM measurement reporting based at least in part on the SCell being included in the one or more SCells configured for the fast SCell RRM measurement reporting in some embodiments.

In some embodiments, the SCell activation MAC CE may indicate multiple SCells for the fast SCell RRM measurement reporting. The UE may determine the SCell from the multiple SCells based at least in part on an SCell index for the SCell within the SCell activation MAC CE, the SCell being activated for the fast SCell RRM measurement reporting, or the SCell being activated for the fast SCell RRM measurement reporting and the SCell being determined to meet the condition for the fast SCell RRM measurement reporting in some embodiments.

In some embodiments, the SCell activation MAC CE may indicate multiple SCells for the fast SCell RRM measurement reporting. In some of these embodiments, the procedure 600 may further include assembling multiple measurement reports for the multiple SCells with one measurement report per one SCell of the multiple SCells, assembling a single measurement report that includes measurement results for the multiple SCells, or assembling one or more measurement reports for the multiple SCells with one measurement report per CG corresponding to the multiples SCells.

The procedure 600 may include determining whether a condition for the fast SCell RRM measurement reporting is met in 608. For example, the UE may determine whether a condition for the fast SCell RRM measurement reporting is met.

In some embodiments, determining whether the condition for the fast SCell RRM measurement reporting is met may comprise determining whether an L3 measurement result or an L1 measurement result is available. In these embodiments, the condition for the fast SCell RRM measurement reporting may be met when the L3 measurement result or the L1 measurement result is available.

The procedure 600 may include determining whether to initiate a fast SCell RRM measurement report for the SCell in 610. For example, the UE may determine whether to initiate a fast SCell RRM measurement report for the SCell based at least in part on whether the condition for the fast SCell RRM measurement reporting is met.

In some embodiments, determining whether to initiate the fast SCell RRM measurement report may comprise determining to initiate the fast SCell RRM measurement report. In these embodiments, the procedure 600 may further include generating the fast SCell RRM measurement report for the SCell. The fast SCell RRM measurement report may comprise a cell quality for the SCell or a good/best beam index list. In some embodiments, the fast SCell RRM measurement report may further comprise a beam quality for the SCell.

While FIG. 6 arguably implies an order of operations of the procedure 600, it should be understood that the operations may be performed in a different order and/or one or more of the operations may be performed concurrently in other embodiments. Further, it should be understood that one or more operations of the procedure 600 may be omitted and/or one or more additional operations may be included in the procedure 600 in other embodiments.

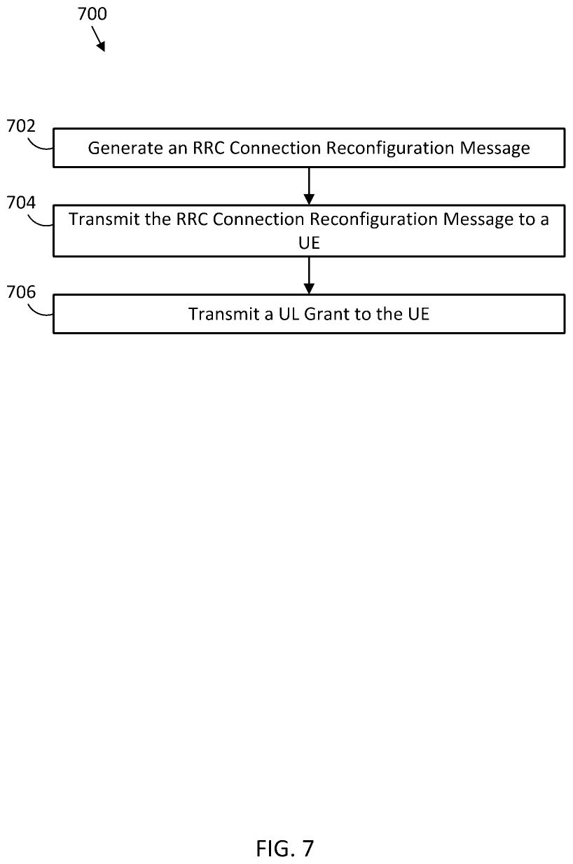

FIG. 7 illustrates an example procedure 700 of operating a base station in accordance with some embodiments. For example, the procedure 700 may facilitate fast SCell RRM measurement reporting. The procedure 700 may be performed by a base station, such as the base station 102 (FIG. 1), the base station 202 (FIG. 2), and/or the gNB 1100 (FIG. 11).

The procedure 700 may include generating an RRC connection reconfiguration message in 702. For example, the base station may generate an RRC connection reconfiguration message including a configuration for a fast SCell RRM measurement reporting. The RRC connection reconfiguration message may include one or more of the features of the RRC connection reconfiguration 110 (FIG. 1) and/or the RRC connection reconfiguration 210 (FIG. 2).

In some embodiments, the configuration for the fast SCell RRM measurement reporting may be included in an SCell addition part or a measurement configuration part of the RRC connection reconfiguration message. Further, the configuration for the fast SCell RRM measurement reporting may comprise a fast SCell measurement report configuration and a serving measurement object in some embodiments. In some embodiments, the configuration for the fast SCell RRM measurement reporting may comprise a new event configuration to trigger a fast SCell measurement report and a beam reporting part configuration.

The procedure 700 may include transmitting the RRC connection reconfiguration message to a UE in 704. For example, the base station may transmit the RRC connection reconfiguration message to a UE to configure the UE for the fast SCell RRM measurement reporting.

In some embodiments, the procedure 700 may further include generating an SCell activation MAC CE that includes one-bit indications for each SCell to indicate SCells for the fast SCell RRM measurement report. The procedure may further include transmitting the SCell activation MAC CE to the UE.

In some embodiments, the procedure 700 may further include generating an SCell activation MAC CE that indicates a single SCell for the fast SCell RRM measurement reporting. The SCell activation MAC CE may indicate the single SCell via a one-bit indication that identifies the single SCell or including an indication of the single SCell within the SCell activation MAC CE. The procedure 700 may further comprise transmitting the SCell activation MAC CE to the UE.

In some embodiments, the procedure 700 may further include generating an SCell activation MAC CE that indicates two or more SCells for the fast SCell RRM measurement reporting. The procedure 700 may further include transmitting the SCell activation MAC CE to the UE. The UE may determine one or more SCells for which to provide one or more SCell RRM measurement reports based at least in part on the two or more SCells indicated within the SCell activation MAC CE.

The procedure 700 may include transmitting a UL grant to the UE in 706. For example, the base station may transmit a UL grant to the UE to enable the fast SCell RRM measurement reporting.

While FIG. 7 arguably implies an order of operations of the procedure 700, it should be understood that the operations may be performed in a different order and/or one or more of the operations may be performed concurrently in other embodiments. Further, it should be understood that one or more operations of the procedure 700 may be omitted and/or one or more additional operations may be included in the procedure 700 in other embodiments.

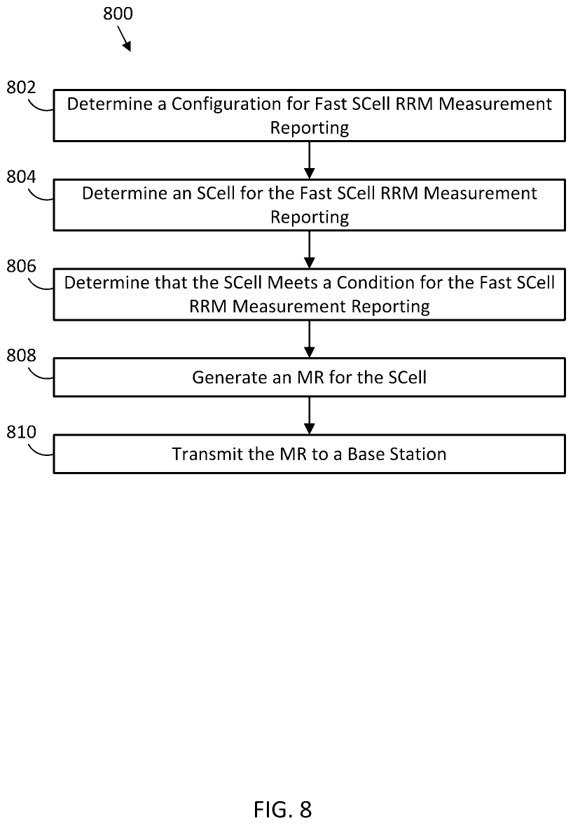

FIG. 8 illustrates an example procedure 800 of operating a UE in accordance with some embodiments. For example, the procedure 800 may facilitate fast SCell RRM measurement reporting. The procedure 800 may be performed by a UE, such as the UE 104 (FIG. 1), the UE 204 (FIG. 2), and/or the UE 1000 (FIG. 10).

The procedure 800 may include determining a configuration for fast SCell RRM measurement reporting in 802. For example, the UE may determine a configuration for fast SCell RRM measurement reporting based at least in part on an RRC connection reconfiguration message received from a base station. The RRC connection reconfiguration message may include one or more of the features of the RRC connection reconfiguration 110 (FIG. 1) and/or the RRC connection reconfiguration 210 (FIG. 2). In some embodiments, the RRC connection reconfiguration message may include the configuration for the fast SCell RRM measurement reporting.

In some embodiments, the configuration for the fast SCell RRM measurement reporting may be received in an SCell addition part of the RRC connection reconfiguration message or a measurement configuration part of the RRC connection reconfiguration. Further, the configuration for the fast SCell RRM measurement reporting may include a fast SCell measurement report configuration in an SCell serving configuration and a serving measurement object in some embodiments. In some embodiments, the configuration for the fast SCell RRM measurement reporting may include a measurement identifier, and an associated measurement object and event configuration.

The procedure 800 may include determining an SCell for the fast SCell RRM measurement reporting in 804. For example, the UE may determine an SCell for the fast SCell RRM measurement reporting.

In some embodiments, the procedure 800 may further include receiving an SCell activation MAC CE that includes a one-bit indication that the SCell is to be activated. The SCell activation MAC CE may include one or more of the features of the SCell activation MAC CE 112 (FIG. 1) and/or the SCell activation MAC CE 212 (FIG. 2). In some of these embodiments, the SCell for the SCell RRM measurement reporting may be determined at least in part on the one-bit indication that the SCell is to be activated.

The procedure 800 may include determining that the SCell meets a condition for the fast SCell RRM measurement reporting in 806. For example, the UE may determine that the SCell meets a condition for the fast SCell RRM measurement reporting. In some embodiments, determining that the SCell meets the condition for the fast SCell RRM measurement reporting may include determining that a measurement report related to the SCell has not been previously provided or provided within a threshold time, determining that an L3 measurement result after L3 filter is available, or determining that an L1 measurement result is available.

The procedure 800 may include generating a measurement report for the SCell in 808. For example, the UE may generate a measurement report for the SCell based at least in part on the determination that the SCell meets the condition for the fast SCell RRM measurement reporting.

In some embodiments, the measurement report may include cell quality for the SCell and a good/best beam index list for the SCell, or a good/best beam index list for the SCell. The measurement report may further include beam quality related to the SCell in some embodiments. Further, the measurement report may include measurement results for multiple SCells including the SCell.

In some embodiments, the procedure 800 may further include generating multiple measurement reports for multiple SCells within one measurement report per one SCell of the multiple SCells, wherein the multiple measurement reports include the measurement for the SCell, or generating one or more measurement reports for multiple SCells with one measurement report per CG corresponding to the multiple SCells, wherein the one or more measurement reports include the measurement report for the SCell.

The procedure 800 may include transmitting the measurement report to the base station in 810. For example, the UE may transmit the measurement report to the base station. In some embodiments, the UE may transmit the measurement report to the base station in an enhanced MR reporting. The enhanced MR reporting may include one or more of the features of the enhanced MR reporting 118 (FIG. 1) and/or the enhanced MR reporting 220 (FIG. 2).

While FIG. 8 arguably implies an order of operations of the procedure 800, it should be understood that the operations may be performed in a different order and/or one or more of the operations may be performed concurrently in other embodiments. Further, it should be understood that one or more operations of the procedure 800 may be omitted and/or one or more additional operations may be included in the procedure 800 in other embodiments.

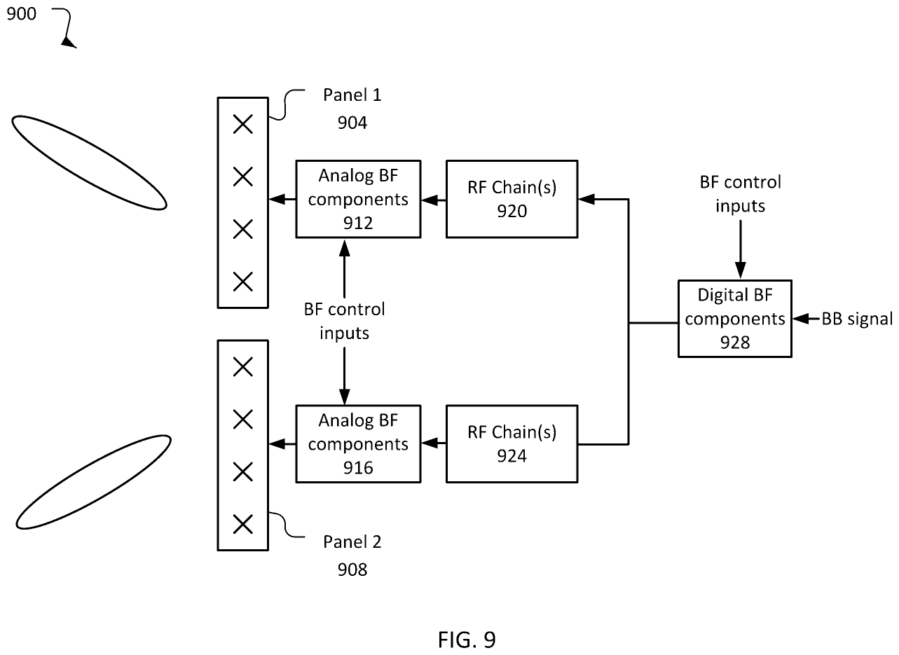

FIG. 9 illustrates example beamforming circuitry 900 in accordance with some embodiments. The beamforming circuitry 900 may include a first antenna panel, panel 1 904, and a second antenna panel, panel 2 908. Each antenna panel may include a number of antenna elements. Other embodiments may include other numbers of antenna panels.

Digital beamforming (BF) components 928 may receive an input baseband (BB) signal from, for example, a baseband processor such as, for example, baseband processor 1004A of FIG. 10. The digital BF components 928 may rely on complex weights to pre-code the BB signal and provide a beamformed BB signal to parallel radio frequency (RF) chains 920/924.

Each RF chain 920/924 may include a digital-to-analog converter to convert the BB signal into the analog domain; a mixer to mix the baseband signal to an RF signal; and a power amplifier to amplify the RF signal for transmission.

The RF signal may be provided to analog BF components 912/916, which may apply additionally beamforming by providing phase shifts in the analog domain. The RF signals may then be provided to antenna panels 904/908 for transmission.

In some embodiments, instead of the hybrid beamforming shown here, the beamforming may be done solely in the digital domain or solely in the analog domain.

In various embodiments, control circuitry, which may reside in a baseband processor, may provide BF weights to the analog/digital BF components to provide a transmit beam at respective antenna panels. These BF weights may be determined by the control circuitry to provide the directional provisioning of the serving cells as described herein. In some embodiments, the BF components and antenna panels may operate together to provide a dynamic phased-array that is capable of directing the beams in the desired direction.

FIG. 10 illustrates an example UE 1000 in accordance with some embodiments. The UE 1000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1000 may be a RedCap UE or NR-Light UE.

The UE 1000 may include processors 1004, RF interface circuitry 1008, memory/storage 1012, user interface 1016, sensors 1020, driver circuitry 1022, power management integrated circuit (PMIC) 1024, antenna structure 1026, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1032, which may represent any type of interface, input/output, bus (local, system, or expansion), transmission line, trace, optical connection, etc. that allows various circuit components (on common or different chips or chipsets) to interact with one another.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform operations as described herein.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1012 may include one or more non-transitory, computer-readable media that includes instructions (for example, communication protocol stack 1036) that may be executed by one or more of the processors 1004 to cause the UE 1000 to perform various operations described herein. The memory/storage 1012 include any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1008 may include transceiver circuitry and radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1008 may be configured to transmit/receive signals in a manner compatible with NR access technologies.

The antenna 1026 may include antenna elements to convert electrical signals into radio waves to travel through the air and to convert received radio waves into electrical signals. The antenna elements may be arranged into one or more antenna panels. The antenna 1026 may have antenna panels that are omnidirectional, directional, or a combination thereof to enable beamforming and multiple input, multiple output communications. The antenna 1026 may include microstrip antennas, printed antennas fabricated on the surface of one or more printed circuit boards, patch antennas, phased array antennas, etc. The antenna 1026 may have one or more panels designed for specific frequency bands including bands in FR1 or FR2.

In some embodiments, the UE 1000 may include the beamforming circuitry 900 (FIG. 9), where the beamforming circuitry 900 may be utilized for communication with the UE 1000. In some embodiments, components of the UE 1000 and the beamforming circuitry may be shared. For example, the antennas 1026 of the UE may include the panel 1 904 and the panel 2 908 of the beamforming circuitry 900.

The user interface circuitry 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1000.

The sensors 1020 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within, or connected to, the UE 1000. For example, driver circuitry 1022 may include a display driver to control and allow access to a display device, a touchscreen driver to control and allow access to a touchscreen interface, sensor drivers to obtain sensor readings of sensor circuitry 1020 and control and allow access to sensor circuitry 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

In some embodiments, the PMIC 1024 may control, or otherwise be part of, various power saving mechanisms of the UE 1000. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1000 may power down for brief intervals of time and thus save power. If there is no data traffic activity for an extended period of time, then the UE 1000 may transition off to an RRC_Idle state, where it disconnects from the network and does not perform operations such as channel quality feedback, handover, etc. The UE 1000 goes into a very low power state and it performs paging where again it periodically wakes up to listen to the network and then powers down again. The UE 1000 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1028 may power the UE 1000, although in some examples the UE 1000 may be mounted deployed in a fixed location, and may have a power supply coupled to an electrical grid. The battery 1028 may be a lithium ion battery, a metal-air battery, such as a zinc-air battery, an aluminum-air battery, a lithium-air battery, and the like. In some implementations, such as in vehicle-based applications, the battery 1028 may be a typical lead-acid automotive battery.

FIG. 11 illustrates an example gNB 1100 in accordance with some embodiments. The gNB 1100 may include processors 1104, RF interface circuitry 1108, core network (CN) interface circuitry 1112, memory/storage circuitry 1116, and antenna structure 1126.

The components of the gNB 1100 may be coupled with various other components over one or more interconnects 1128.

The processors 1104, RF interface circuitry 1108, memory/storage circuitry 1116 (including communication protocol stack 1110), antenna structure 1126, and interconnects 1128 may be similar to like-named elements shown and described with respect to FIG. 10.

The CN interface circuitry 1112 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1100 via a fiber optic or wireless backhaul. The CN interface circuitry 1112 may include one or more dedicated processors or FPGAs to communicate using one or more of the aforementioned protocols. In some implementations, the CN interface circuitry 1112 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method of operating a user equipment (UE), comprising receiving a radio resource control (RRC) connection reconfiguration message from a base station, determining a configuration for fast secondary cell (SCell) radio resource management (RRM) measurement reporting based at least in part on the RRC connection reconfiguration message, determining an SCell for the fast SCell RRM measurement reporting, determining whether a condition for the fast SCell RRM measurement reporting is met, and determining whether to initiate a fast SCell RRM measurement report for the SCell based at least in part on whether the condition for the fast SCell RRM measurement reporting is met.

Example 2 may include the method of example 1, wherein the RRC connection reconfiguration message comprises the configuration for the fast SCell RRM measurement reporting in an SCell addition part of the RRC connection reconfiguration message or a measurement configuration part of the RRC connection reconfiguration message.

Example 3 may include the method of example 1, further comprising receiving an SCell activation medium access control (MAC) control element (CE), wherein the SCell activation MAC CE triggers the fast SCell RRM measurement reporting.

Example 4 may include the method of example 1, further comprising receiving an SCell activation medium access control (MAC) control element (CE) that includes one-bit indications for each SCell in the SCell activation MAC CE, wherein the SCell for the fast SCell RRM measurement reporting is determined based at least in part on the one-bit indications within the SCell activation MAC CE.

Example 5 may include the method of example 4, wherein the SCell activation MAC CE is received via a MAC layer of the UE, and wherein the method further comprises indicating, via the MAC layer of the UE to an RRC layer of the UE, an SCell index corresponding to the SCell for the fast SCell RRM measurement reporting to indicate that the fast SCell RRM measurement reporting is to be performed for the SCell.

Example 6 may include the method of example 4, further comprising indicating, via an RRC layer of the UE to a MAC layer of the UE, one or more SCells configured for the fast SCell RRM measurement reporting, and indicating, via the MAC layer of the UE to the RRC layer of the UE, the SCell for the fast SCell RRM measurement reporting based at least in part on the SCell being included in the one or more SCells configured for the fast SCell RRM measurement reporting.

Example 7 may include the method of example 4, wherein the SCell activation MAC CE indicates multiple SCells for the fast SCell RRM measurement reporting, and wherein the UE determines the SCell from the multiple SCells based at least in part on an SCell index for the SCell within the SCell activation MAC CE, the SCell being activated for the fast SCell RRM measurement reporting, or the SCell being activated for the fast SCell RRM measurement reporting and the SCell being determined to meet the condition for the fast SCell RRM measurement reporting.

Example 8 may include the method of example 4, wherein the SCell activation MAC CE indicates multiple SCells for the fast SCell RRM measurement reporting, and wherein the method further comprises assembling multiple measurement reports for the multiple SCells with one measurement report per one SCell of the multiple SCells, assembling a single measurement report that includes measurement results for the multiple SCells, or assembling one or more measurement reports for the multiple SCells with one measurement report per cell group corresponding to the multiple SCells.

Example 9 may include the method of example 1, wherein determining whether a condition for the fast SCell RRM measurement reporting is met comprises determining whether a layer 3 (L3) measurement result or a layer 1 (L1) measurement result is available, wherein the condition for the fast SCell RRM measurement reporting is met when the L3 measurement result or the L1 measurement result is available.

Example 10 may include the method of example 1, wherein determining whether to initiate the fast SCell RRM measurement report comprises determining to initiate the fast SCell RRM measurement report, and wherein the method further comprises generating the fast SCell RRM measurement report for the SCell, wherein the fast SCell RRM measurement report comprises a cell quality for the SCell or a good/best beam index list.

Example 11 may include the method of example 10, further comprising identifying an uplink (UL) grant for a resource for transmission of the fast SCell RRM measurement report, the resource being a first resource granted for UL transmission after the fast SCell RRM measurement report is ready for transmission, and transmitting the fast SCell RRM measurement report to the base station via the resource.

Example 12 may include the method of example 10, further comprising identifying an uplink (UL) grant for a component carrier (CC) for transmission of the fast SCell RRM measurement report, the CC corresponding to a cell group (CG) that includes the SCell, and the CC being a first CC granted for the CG for UL transmission after the fast SCell RRM measurement report is ready for transmission, and transmitting the fast SCell RRM measurement report to the base station via the resource.

Example 13 may include the method of example 10, wherein the fast SCell RRM measurement report further comprises a beam quality for the SCell.

Example 14 may include the method of example 1, wherein the configuration for the fast SCell RRM measurement reporting comprises a fast SCell measurement report (MR) configuration and a serving measurement object (ServingMO).

Example 15 may include a method of operating a base station, comprising generating a radio resource control (RRC) connection reconfiguration message including a configuration for a fast secondary cell (SCell) radio resource management (RRM) measurement reporting, transmitting the RRC connection reconfiguration message to a user equipment (UE) to configure the UE for the fast SCell RRM measurement reporting, and transmitting an uplink (UL) grant to the UE to enable the fast SCell RRM measurement reporting.

Example 16 may include the method of example 15, wherein the configuration for the fast SCell RRM measurement reporting is included in an SCell addition part or a measurement configuration part of the RRC connection reconfiguration message.

Example 17 may include the method of example 15, wherein the configuration for the fast SCell RRM measurement reporting comprises a fast SCell measurement report (MR) configuration and a serving measurement object.

Example 18 may include the method of example 15, wherein the configuration for the fast SCell RRM measurement reporting comprises a new event configuration to trigger a fast SCell measurement report (MR) and a beam reporting part configuration.

Example 19 may include the method of claim 15, further comprising generating an SCell activation medium access control (MAC) control element (CE), wherein the SCell activation MAC CE is to trigger the fast SCell RRM measurement reporting by the UE.

Example 20 may include the method of example 15, further comprising generating an SCell activation medium access control (MAC) control element (CE) that includes one-bit indications for each SCell to indicate SCells for the fast SCell RRM measurement report, and transmitting the SCell activation MAC CE to the UE.

Example 21 may include the method of example 15, further comprising generating an SCell activation medium access control (MAC) control element (CE) that indicates a single SCell for the fast SCell RRM measurement reporting, the SCell activation MAC CE indicating the single SCell via a one-bit indication that identifies the single SCell or including an indication of the single SCell within the SCell activation MAC CE, and transmitting the SCell activation MAC CE to the UE.

Example 22 may include the method of example 15, further comprising generating an SCell activation medium access control (MAC) control element (CE) that indicates two or more SCells for the fast SCell RRM measurement reporting, and transmitting the SCell activation MAC CE to the UE, the UE to determine one or more SCells for which to provide one or more SCell RRM measurement reports (MRs) based at least in part on the two or more SCells indicated within the SCell activation MAC CE.

Example 23 may include a method of operating a user equipment (UE), comprising determining a configuration for fast secondary cell (SCell) radio resource management (RRM) measurement reporting based at least in part on a radio resource control (RRC) connection reconfiguration message received from a base station, the RRC connection reconfiguration message including the configuration for the fast SCell RRM measurement reporting, determining an SCell for the fast SCell RRM measurement reporting, determining that the SCell meets a condition for the fast SCell RRM measurement reporting, generating a measurement report (MR) for the SCell based at least in part on the determination that the SCell meets the condition for the fast SCell RRM measurement reporting, and transmitting the MR to the base station.

Example 24 may include the method of example 23, wherein the configuration for the fast SCell RRM measurement reporting is received in an SCell addition part of the RRC connection reconfiguration message or a measurement configuration part of the RRC connection reconfiguration message.

Example 25 may include the method of example 23, wherein the configuration for the fast SCell RRM measurement reporting comprises a fast SCell MR configuration in an SCell serving configuration and a serving measurement object (servingMO).

Example 26 may include the method of example 23, wherein the configuration for the fast SCell RRM measurement reporting comprises a measurement identifier, and an associated measurement object (MO) and event configuration.

Example 27 may include the method of example 23, wherein determining that the SCell meets the condition for the fast SCell RRM measurement reporting comprises determining that a measurement report related to the SCell has not been previously provided or provided within a threshold time, determining that a layer 3 (L3) measurement result after L3 filter is available, or determining that a layer 1 (L1) measurement result is available.

Example 28 may include the method of example 23, further comprising receiving an SCell activation medium access control (MAC) control element (CE) that includes a one-bit indication that the SCell is to be activated, wherein the SCell for the SCell RRM measurement reporting is determined at least in part on the one-bit indication that the SCell is to be activated.

Example 29 may include the method of example 23, wherein the MR comprises cell quality for the SCell and a good/best beam index list for the SCell, or a good/best beam index list for the SCell.

Example 30 may include the method of example 29, wherein the MR further comprises beam quality related to the SCell.

Example 31 may include the method of example 23, wherein the MR includes measurement results for multiple SCells including the SCell.

Example 32 may include the method of example 23, further comprising generating multiple MRs for multiple SCells with one measurement report per one SCell of the multiple SCells, wherein the multiple MRs include the MR for the SCell, or generating one or more MRs for multiple SCells with one MR per cell group (CG) corresponding to the multiple SCells, wherein the one or more MRs include the MR for the SCell.

Example 33 may include an apparatus comprising means to perform one or more elements of a method described in or related to any of examples 1-32, or any other method or process described herein.

Example 34 may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Example 35 may include an apparatus comprising logic, modules, or circuitry to perform one or more elements of a method described in or related to any of examples 1-32, or any other method or process described herein.

Example 36 may include a method, technique, or process as described in or related to any of examples 1-32, or portions or parts thereof.

Example 37 may include an apparatus comprising: one or more processors and one or more computer-readable media comprising instructions that, when executed by the one or more processors, cause the one or more processors to perform the method, techniques, or process as described in or related to any of examples 1-32, or portions thereof.

Example 38 may include a signal as described in or related to any of examples 1-32, or portions or parts thereof.

Example 39 may include a datagram, information element, packet, frame, segment, PDU, or message as described in or related to any of examples 1-32, or portions or parts thereof, or otherwise described in the present disclosure.

Example 40 may include a signal encoded with data as described in or related to any of examples 1-32, or portions or parts thereof, or otherwise described in the present disclosure.

Example 41 may include a signal encoded with a datagram, IE, packet, frame, segment, PDU, or message as described in or related to any of examples 1-32, or portions or parts thereof, or otherwise described in the present disclosure.

Example 42 may include an electromagnetic signal carrying computer-readable instructions, wherein execution of the computer-readable instructions by one or more processors is to cause the one or more processors to perform the method, techniques, or process as described in or related to any of examples 1-32, or portions thereof.

Example 43 may include a computer program comprising instructions, wherein execution of the program by a processing element is to cause the processing element to carry out the method, techniques, or process as described in or related to any of examples 1-32, or portions thereof.

Example 44 may include a signal in a wireless network as shown and described herein.

Example 45 may include a method of communicating in a wireless network as shown and described herein.

Example 46 may include a system for providing wireless communication as shown and described herein.

Example 47 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1-40. (canceled)

41. A method comprising:
receiving a configuration element to configure measurement reporting associated with fast unknown secondary cell (SCell) activation;
receiving a medium access control (MAC) control element (CE) to activate an unknown SCell; and
generating, based at least in part on the configuration element and the MAC CE, a measurement report that includes measurement information for the unknown SCell.

42. The method of claim 41, wherein the MAC CE includes an SCell MAC CE.

43. The method of claim 41, wherein the configuration element includes a radio resource control (RRC) configuration.

44. The method of claim 41, wherein another measurement report for the unknown SCell has not been previously provided or has not been previously provided within a threshold amount of time from receiving the MAC CE.

45. The method of claim 41, further comprising:
generating multiple measurement reports, the multiple measurement reports including the measurement report, wherein the multiple measurement reports include one measurement report per one SCell.

46. The method of claim 41, wherein the measurement report corresponds to a cell group, wherein the unknown SCell is included in the cell group.

47. The method of claim 41, further comprising:
identifying that a layer 3 (L3) measurement result or a layer 1 (L1) measurement result is available for the unknown SCell, wherein the measurement report is generated based at least in part on the L3 measurement result or the L1 measurement result being available.

48. An apparatus comprising:
interface circuitry; and
processing circuitry, coupled with the interface circuitry, the processing circuitry to:
receive a medium access control (MAC) control element (CE) from the interface circuitry, the MAC CE to activate an unknown secondary cell (SCell); and
generate, based at least in part on the MAC CE, a measurement report for the unknown SCell.

49. The apparatus of claim 48, wherein the processing circuitry is further to:
receive a configuration element to configure measurement reporting associated with fast unknown SCell activation, wherein the measurement report is generated in accordance with the configuration element.

50. The apparatus of claim 49, wherein the configuration element includes a radio resource control (RRC) configuration.

51. The apparatus of claim 48, wherein the MAC CE includes an SCell MAC CE

52. The apparatus of claim 48, wherein another measurement report for the unknown SCell has not been previously provided or has not been previously provided within a threshold amount of time from reception of the MAC CE.

53. The apparatus of claim 48, wherein the measurement report corresponds to a cell group, wherein the measurement report includes additional measurement information for other SCells within the cell group.

54. The apparatus of claim 48, wherein the processing circuitry is further to:
identify that a layer 3 (L3) measurement result or a layer 1 (L1) measurement result is available for the unknown SCell, wherein the measurement report is generated based at least in part on the L3 measurement result or the L1 measurement result being available.

55. The apparatus of claim 48, wherein the processing circuitry is further to:
generate multiple measurement reports, the multiple measurements reports including the measurement report, wherein the multiple measurement reports include one measurement report per one SCell.

56. A method comprising:
generating, for transmission, a configuration element to configure measurement reporting associated with fast unknown secondary cell (SCell) activation;
generating, for transmission, a medium access control (MAC) control element (CE) to activate an unknown SCell; and
receiving a measurement report for the unknown SCell based at least in part on the configuration element and the MAC CE.

57. The method of claim 56, wherein the MAC CE includes an SCell MAC CE

58. The method of claim 56, wherein the MAC CE includes at least one SCell index for SCells to be activated, wherein an SCell index of the at least one SCell index corresponds to the unknown SCell.

59. The method of claim 56, wherein the configuration element includes a radio resource control (RRC) configuration.

60. The method of claim 56, wherein the measurement report corresponds to a cell group, and wherein the measurement report includes measurement results for at least one other SCell.
